(19) United States
(12) Patent Application Publication
(10) Pub. No.: US 2021/0218884 A1
(43) Pub. Date: Jul. 15, 2021

(54) INFORMATION PROCESSING DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Manabu Nishiyama, Setagaya Tokyo (JP)

(21) Appl. No.: 16/991,887

(22) Filed: Aug. 12, 2020

(30) Foreign Application Priority Data
Jan. 15, 2020 (JP) 2020-004324

(51) Int. Cl. H04N 5/232; H04N 7/18; G06K 9/00

(52) U.S. Cl. CPC H04N 5/23229; G06K 9/00805; H04N 7/181

(57) ABSTRACT

According to one or more embodiments, an information processing device includes a processor to receive input signals from a plurality of external devices and to receive a plurality of sensor signals from a plurality of sensors. The processor selects a processing mode for each input signal from the plurality of external devices based at least in part on the plurality of sensor signals. The processing mode is selected from available processing modes which include a normal mode and a low load mode. The low load mode has a lower processing load than the normal mode. The processor processes a first input signal in the low load mode and a second input signal in the normal mode.

### CROSS-REFERENCE TO RELATED APPLICATION(S)

This application is based upon and claims the benefit of priority from Japanese Patent Application No. 2020-004324, filed on Jan. 15, 2020, the entire contents of which are incorporated herein by reference.

### FIELD

Embodiments described herein relate generally to an information processing device, an image processing device and a non-transitory computer readable medium storing an information processing program.

### BACKGROUND

Monitoring a periphery or a surrounding area of a vehicle has been performed for various purposes such as object detection and obstacle avoidance. It is often preferred to process all images captured for various sensor purposes with one System-on-Chip (SoC) in view of cost and/or similarity with other sensor information. On the other hand, processing various images by just one SoC may make hardware resources and the like scarce relative to the number of images to be processed, and thus a desired processing time for the various images may not be achieved. For example, in obstacle avoidance, a processing load may be reduced by limiting the image processing to particular acquisition times and image areas, but the reduction in the processing load will vary according to circumstance, and as a result, sustainable reduction in the processing load may not be properly estimated.

### DESCRIPTION OF THE DRAWINGS

FIG. 1 depicts a configuration of an information processing device according to an embodiment.

FIG. 2 is a flowchart of a processing by an information processing device according to an embodiment.

FIG. 3 depicts another configuration of an information processing device according to an embodiment.

FIG. 4 depicts an example of an implementation of an information processing device according to an embodiment.

### DETAILED DESCRIPTION

According to one or more embodiments, an information processing device includes a processor configured to receive input signals from a plurality of external devices and to receive a plurality of sensor signals from a plurality of sensors. The processor is configured to select a processing mode for each input signal from the plurality of external devices based at least in part on the plurality of sensor signals. The processing mode is selected from available processing modes which include a normal mode and a low load mode. Processing of the input signals performed in low load mode requires a lower processing load than processing of the input signals in the normal mode. The processor processes a first input signal from one of the external devices in the low load mode and a second input signal in the normal mode.

Hereinafter, certain embodiments will be described with reference to the accompanying drawings. As one example embodiment, an information processing device mounted on a moving body such as a vehicle will be described. The present disclosure is, however, not limited thereto.

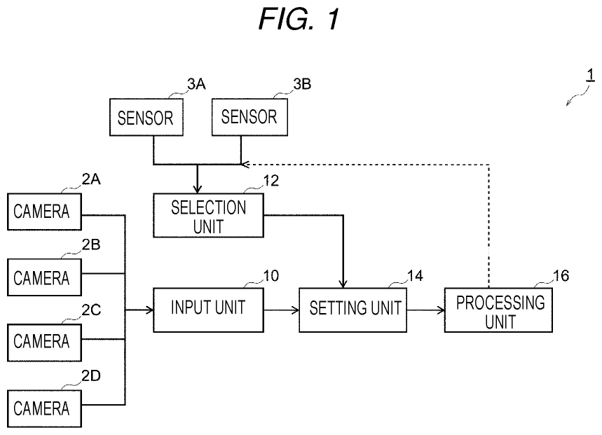

FIG. 1 is a block diagram schematically illustrating an information processing device 1 according to an embodiment. The information processing device 1 comprises an input unit 10, a selection unit 12, a setting unit 14, and a processing unit 16. The information processing device 1 may further comprise a storage unit configured to store various data and programs therein.

The information processing device 1 is configured to select a signal suitable for processing with a lower load than a normal load from among a plurality of signals input thereto via the input unit 10 ,based on information related to various statuses, factors, criteria, and the like pertaining to a moving body (e.g., a vehicle) equipped with the information processing device 1. The processing device 1 then switches the processing of the selected signal to the low load processing to reduce the processing load.

The input unit 10 receives input signals from one or more external devices, separate apparatuses, or the like. For example, the input unit 10 receives image data, as the input signals, from a plurality of cameras 2A, 2B, 2C, and 2D (also collectively referred to as cameras 2 herein), which are provided on a vehicle to capture images showing external states or peripheral areas of the vehicle. The cameras 2 may be mounted or equipped on a vehicle such that they capture peripheral images of multiple sides, such as the front, rear, left and right sides, of the vehicle. The input signals are not limited to the signals from the cameras 2. In other embodiments, input signals may be or include signals from various other sensors such as ultrasonic sensors and the like. In the case where the image data is being subjected to the processing, the information processing device 1 may be referred to as the image processing device, and the processing may be referred to as the image processing.

The selection unit 12 acquires signals from a sensor or sensors, and then selects whether to process signal data acquired from the input unit 10 in a low-load processing mode (low-load mode) or a normal processing mode (normal mode). In this context, “normal mode” refers to a mode in which normal (standard) information processing is performed on the acquired signal data, and “low-load mode” refers to a mode in which an information processing is performed at a lower processing load than the normal mode. In one embodiment, the selection unit 12 may receive output signals from the sensors 3 configured to sense the speed of the vehicle and/or turn status including a present turning amount, a turn direction, or the like of the vehicle. The selection unit 12 then selects image data received from a camera 2 to be subjected to the low load processing, based on the vehicle speed data and/or turn data. The selection unit 12 may determine whether to execute the normal processing or the low load processing for each frame of the acquired image data. In another embodiment, the selection unit 12 may regularly (e.g., in a predetermined order or at predetermined times) select data to be subjected to the low load processing, rather than selecting the processing mode based on the various conditions as described above.

The setting unit 14 sets the processing mode for each of the input signals based on the selection of the selection unit 12. For example, when the selection unit 12 selects the signal received from the camera 2A to be subjected the low load processing, the setting unit 14 sets the image processing to the low load mode for that signal or image data from the camera 2A.

The processing unit 16 is configured to perform a signal processing on data received from the input unit 10. In the present embodiment, when the images captured by the cameras 2 are input via the input unit 10, the processing unit 16 executes image processing for various purposes. More specifically, for example, the processing unit 16 may execute an image processing capable of detecting and identifying an obstacle or obstacles in the input image.

Furthermore, the processing unit 16 is configured to execute the image processing based on the particular mode that has been set by the setting unit 14 at the processing time. In the present embodiment, if the setting unit 14 sets the processing mode for the image data from the camera 2A to the low load mode, the processing unit 16 executes the low load image processing on that image data. If the setting unit 14 sets the processing mode for output from the camera 2B to the normal mode, the processing unit 16 executes the normal image processing on the image data from the camera 2B.

The image processing to be executed by the processing unit 16 may include, for example, an image processing for detecting an object, an image processing for detecting a position or orientation of the vehicle itself, and other appropriate image data processing to achieve desired image processing effects and functions. Further, the image processing may include a pre-processing and a post-processing of the corresponding image data being processed. For example, some or all of steps or processes for visual Simultaneous Localization And Mapping (SLAM) may be executed.

While the selection unit 12 selects one or more input signals or data to be subjected to the low load processing in the above-described embodiment, the present disclosure is not limited thereto. For example, the selection unit 12 may be configured to select whether to execute a processing in the low load mode or in the normal mode with respect to the input signals received from the respective cameras 2. That is, the selection unit 12 may select which processing mode to be used, the normal mode or the low load mode, for each of the input signals, rather than selecting a signal or signals to be subjected to the low load mode.

Further, the possible processing modes are not limited to the low load mode and the normal mode. For example, the processing modes may include an ultra-low mode in addition to the normal and low load modes. In such a case, the respective modes may be indicated by numerical values, for example, 3 for the normal mode, 2 for the low load mode, and 1 for the ultra-low load mode, and the processing may be switched according to these numerical values. In another embodiment, a high load mode in which a processing is executed at a higher load than a normal load may be utilized. In this way, not only switching between two modes but also switching between multiple modes may be performed.

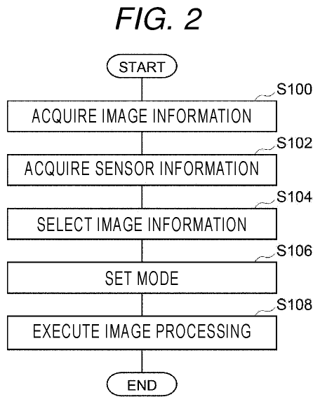

FIG. 2 is a flowchart of the processing in the case where the image information is input to the information processing device 1 as the input signals according to the present embodiment.

First, image information is acquired by the plurality of cameras 2 mounted on the vehicle and connected to the information processing device 1 (S100). Each of the plurality of cameras acquires the image information relating to the surrounding situation of the vehicle. The acquired information is input to the information processing device 1 via the input unit 10.

Next, the selection unit 12 acquires sensed information as the sensor signals from a sensor 3 attached to the vehicle and connected to the information processing device 1 (S102). The sensor 3 is, for example, a speed sensor that senses the speed of the vehicle, a turning amount sensor that senses the turning amount of the vehicle, and/or a torque sensor that senses the torque amount of the vehicle. A plurality of different sensors 3 may be provided. The selection unit 12 may also acquire a result of a processing performed by the processing unit 16 to acquire information regarding the state in which the vehicle is placed. The processing result may include a result of an image processing on a previous frame of the image data. The information regarding the state in which the vehicle is presently placed may be information such as a position of an obstacle or a positional relationship with respect to other vehicles. In addition to this information, the selection unit 12 may acquire other appropriate information for making a determination to select the signal or signals to be subjected to the low load processing or select the signal processing modes for the respective signals.

The two steps S100 and S102 need not be performed in the order as described above or shown in FIG. 2. The order of performing these steps may be reversed. In another embodiment, the two steps may be simultaneously executed in parallel, for example, by separate processors. In still another embodiment, the acquisition of image information and the acquisition of sensor information need not be executed at the same time or in a same time span. They may be performed asynchronously, for example.

After the above steps, the selection unit 12 selects image information to be subjected to the low load processing among the input image information based on the acquired sensor information from the sensors 3 and/or the information from the processing unit 16 (S104). In one embodiment, this selection may be determined based on information such as the positional information of the cameras 2 and at least one of the speed, turn, and torque data of the vehicle acquired from the sensors 3. In another embodiment, the selection unit 12 may select one or more cameras among the cameras 2, rather than selecting the image information among the input image information. In this case, all image information output from the selected cameras 2 will be subjected to the processing in the low load mode.

The setting unit 14 then sets the processing to be performed on the image information, or more specifically image data, selected by the selection unit 12 to the low load mode (S106). The processing to be performed on non-selected data is set to the normal mode by default. In an alternative embodiment, three or more processing modes may be utilized, and the setting unit 14 sets the appropriate mode for the selected data and the non-selected data from the available modes instead of just switching between two modes.

While the processes of S104 and S106 have been described as setting the low load mode for the selected image information or the selected cameras 2, the present disclosure is not limited thereto. For example, the setting unit 14 may set the processing mode for each image or camera signal based on the acquired sensor information from the sensors 3 without using the selection unit 12. In such a case, the selection unit 12 need not necessarily be provided as long as the processing modes may be properly set for each image or camera based on the information from the sensors or the like. In this case, the setting unit 14 may be directly connected to the sensors 3. In either case, the setting unit 14 may set the processing mode for data acquired by the respective cameras 2 based on information from the sensors 3. As another example, the setting unit 14 may set the processing mode for each of the cameras 2 individually based on sensed information from the sensor. By setting the processing mode for each camera, if consecutive data is input from one camera, the processing mode for the entirety of the consecutive data from that specific camera may be set at once.

Finally, the processing unit 16 executes appropriate processing based on the modes set by the setting unit 14 (S108). The processing unit 16 executes an image processing in the normal mode on the data set to the normal mode and executes an image processing in the low load mode on data set to the low load mode. The image processing in the low load mode is, for example, a processing where calculation costs and/or time costs are lower than those of the image processing in the normal mode. The degree of reduction in the processing load such as the calculation costs and the time costs of the image processing in the low load mode may be estimated in advance by comparing with the image processing load in the normal mode. If the reduction target of the calculation costs and/or the time costs is determined based on the estimation, a number of data need to be set to the low load mode may also be calculated in advance.

In this way, the information processing device 1 may select the processing modes based at least on the sensor information acquired from the sensors 3 and execute the processing based on the selected modes.

Further details of the mode setting processes from S102 to S106 according to one or more embodiments will be described below.

In the case in which the selection unit 12 selects a camera from the plurality of cameras 2 provided on the moving body (e.g., a vehicle) to provide an image to be processed in the low load mode, this selection of the camera may be determined based on, for example, the movement direction and/or the speed of the moving body. The selection may also be determined based on a positional relationship of an obstacle in an image acquired in a previous frame.

In the case where Visual SLAM is utilized, either a camera or output data from the camera may be identified or selected for the low-load processing.

For example, the output from a camera pointing in a direction opposite to the traveling direction of the moving body may be set to be processed with the low load mode. This is because any obstacle present in the direction opposite to the traveling direction generally has a lower possibility of causing a collision or the like as compared to obstacles in the movement path (direction) of the moving body.

In another embodiment, output from a camera that is pointed in the traveling direction may be set to be processed with the high-load mode. In an alternative embodiment, output from any camera that is pointed away from (opposite) to the traveling direction may be set to an ultra-low load mode, any other camera not pointed (or otherwise acquiring images) in the traveling direction may be set to the low-load mode, and the camera(s) oriented in the traveling direction may be set to the normal mode.

In still another embodiment, an output from the camera that captures an image of the inner side of the turn movement of the moving body may be set to be processed with the low load mode. This is because an obstacle existing in the inner side of the turn may show a lesser relative movement in captured images from such a camera, which may cause difficulty in three-dimensional estimations by visual SLAM and tends to have a lesser effect on the degree of precision even when the processing is performed in a reduced frame, as compared with an obstacle existing in the outer side of the turn.

In the case where the high load mode is available in addition to the other modes, the camera that is oriented to the outer side of the turn may be set to the high load mode . In the case where the ultra-low load mode is selectable, the camera that is oriented to the inner side of the turning direction may be set to the ultra-low load mode, the camera that is oriented to the outer side of the turning direction may be set to the normal mode, and the other cameras may be set to the low load mode.

In some examples, output from a camera having one or more previous frames in which no obstacle was detected by the processing of the processing unit 16 may be set to be processed with the low load mode. This is because the possibility of collision or the like is low since no obstacle has been detected in one or more previous frames and a relatively high safety is secured even though the load of such a specific camera is reduced as compared with instead reducing the load of other cameras capturing images presently showing an obstacle.

In one embodiment, in a case of an automobile, the output from a camera capturing an image in the same visual range as the range that may be seen by a driver may be set to be processed in the low load mode. On the other hand, output from a camera capturing an image of an area/range not readily seen by the driver may be selected to have a low possibility of being processed in the low load mode. In this way, the data to be processed in the low load mode may be selected and set based on what a driver can and cannot normally see.

In one embodiment, when Light Detection And Ranging (LiDAR) sensor is used in addition to a camera, an output from a camera that captures an image of the same direction as a LiDAR sensor may be set to be processed in the low load mode. In such a way, data to be processed in the low load mode may be selected based on a function/presence of another sensor on the moving body.

The mode setting processes or mode selection methods that have been described may be used in combination. For example, the mode may be determined based on both the traveling direction of the moving body and the turning direction of the moving body. Another example may be to use both the sensing direction of a non-camera sensor on the moving body and the traveling direction of the moving body.

When different mode setting/selection criteria are used as a means of determining the mode, weightings (or value scores) for each of the different criteria may be set to −1, 0, or +1, for example, and the mode may then be determined and set based on the total score in view of values pre-assigned to each of the different mode setting/selection criteria.

The connection with the sensors 3 for obtaining such information may be implemented via a controller area network (CAN) or the like for an automobile. The connection may also be one that enables communication using other appropriate protocols.

The selection unit 12 is not necessarily limited to the above examples, and may instead select cameras that outputs image information to be subjected to the low load image processing in a regularized manner such as a predetermined regular-order for respective frames of the image capture, without using additional sensor information or the like. For example, when the multiple cameras 2 are connected to the information processing device 1, as illustrated in FIG. 1, the selection unit 12 may perform the selection according to a predetermined order where the camera 2A is first selected for the low load processing in one frame, subsequently the camera 2B is selected for the low load processing in the next frame, and the camera 2C is selected for the low load processing in the following frame.

The number of cameras 2 to be selected for the image processing in the low load mode may be more than one.

In yet another embodiment, the selection unit 12 may select the cameras for the low load processing in an order according to a predetermined rule that is not necessarily uniform for all the respective cameras. Such an order may be camera 2A→camera 2B→camera 2A→camera 2C and so on. This predetermined rule may be designated in advance by a user or the like of the information processing device 1 or may instead be determined by the information processing device 1 based on past information, data or the like stored therein or in a separate storage device. Even in a case where the sensors are not cameras, one or more sensors may be selected from the plurality of sensors such that the signals obtained from the selected sensors are subjected to the processing in the low load mode for frame-like portions (or portions of a time series) of sensor output of according to either a predetermined regular rule or irregular rule.

Next, further details of the process of S108 will be described.

As described above, the processing unit 16 processes the image data acquired by the plurality of cameras 2 provided on the moving body based on the mode (s) selected and set by the selection unit 12 and the setting unit 14. In one embodiment, this processing may limit a frame per second (FPS) and the like of the images acquired from the cameras 2.

With respect to the frame data that is acquired in time series or in real-time, the processing unit 16 may perform the image processing on the frame data selected and set for the low load mode by thinning out or removing (dropping) some frames. For example, the processing unit 16 may execute the image processing at a reduced frame rate on the output data from the camera (s) selected and set for the low load mode processing.

In one embodiment, the processing unit 16 may perform the processing at a reduced resolution on the data selected and set for the low load mode processing. In this case, for example, a low-resolution image may be acquired by a circuit that is capable of executing a filter such as an average filter and the like. As another example, data may be acquired only for a predetermined number of pixels.

The processing unit 16 may divide the image processing into a plurality of phases and may execute all of the phases on some frames and execute only some of the phases in the remaining frames with respect to the data set for the low load mode processing.

The processing unit 16 may execute the image processing on a part of an image with respect to the data set for the low load mode processing. For example, the processing unit 16 might only process the lower half area of the frame, the right half area of the frame, or the area near the center of the frame. The frame area (sub-area of a frame) in which the processing is to be executed may be set in advance or may be determined based on movements of the moving body, a present positional relationship with an obstacle or the like. Such sub-areas may also be set for processing in the normal mode. For example, the processing unit 16 may execute the image processing in the low load mode on an area narrower than the area in which the image processing in the normal mode is performed.

In one embodiment, when an image recognition processing is performed using the visual SLAM, all processing phases including three-dimensional estimation may be executed in some frames, and partial phases up to movement estimation may be executed in the remaining frames. By performing the processing in this way, for example, the positional information of the moving body itself may be continuously obtained while the recognition processing may be performed for just a predetermined number of frames.

In another embodiment, all processing phases including the three-dimensional estimation may be executed in some frames, and only the three-dimensional estimation processing may be executed in the remaining frames. By performing the processing in this way, for example, while the three-dimensional estimation processing on the periphery of the moving body may be continuously performed using the positional information of the moving body acquired from images by other cameras, the positional information of the camera and the positional information with respect to the other cameras may be compared and corrected for a predetermined number of frames.

In some examples, the above-described processing may be divided into sub-processes and in some instances such processing may be rearranged or performed so as to differ from of the processing flows described above. For example, if the processing in the normal mode comprises A+B, that is a combination of processing A and processing B, the processing may be divided during the low load mode such that the processing A is executed in some frames and the processing B is executed in other frames. In this way, in the low load mode, some sub-part of the processing of the normal mode may be executed in only some frames.

As described above, according to the present embodiments, in the case where the detection of an obstacle to the vehicle is performed, the sensor information is acquired from the various sensors 3 on the vehicle, and based on the sensor information, the processing modes are appropriately set for the acquired image information so that a reduction in calculation costs and/or time costs may effectively be achieved. Through the reduction of cost, for example, it is possible to secure the necessary or desired information processing speed and to appropriately detect an obstacle or the like that possibly exist around the moving body.

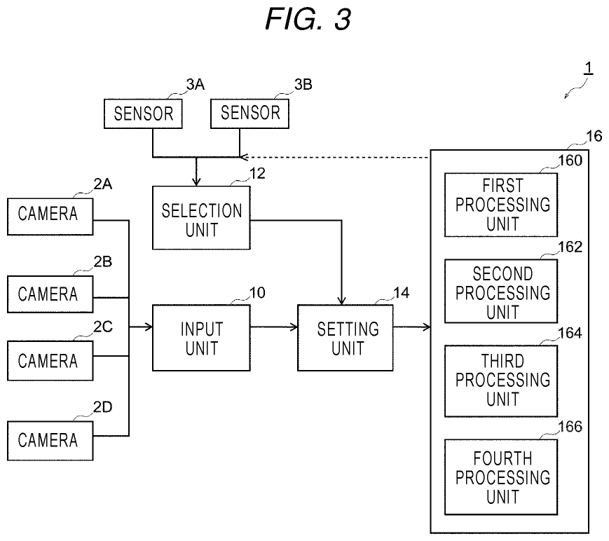

FIG. 3 is a block diagram schematically illustrating another example of the information processing device 1 according to an embodiment. The processing unit 16 may include a first processing unit 160, a second processing unit 162, a third processing unit 164, and a fourth processing unit 166 for different processing.

For example, the first processing unit 160 and the second processing unit 162 may each execute a processing in the normal mode on an input image, and the third processing unit 164 and the fourth processing unit 166 may each execute a processing in the low load mode on an input image. The setting unit 14 may distribute the incoming image data (or the like) to these different processing units according to the processing modes set by the selection unit 12. Each of the different processing units (160, 162, 164, 166) may be implemented by a dedicated circuit, for example.

The number of processing modes may be more than two. For example, in the embodiment of FIG. 3, there may be four processing modes, and the first, second, third, and fourth processing units 160, 162, 164, and 166 may execute first, second, third, and fourth modes, respectively. In other embodiments, the number of processing units may be more than four. Alternatively, there may be only two processing units, one that executes the normal mode and one that executes the low load mode.

In some examples, the processing unit 16 (or each of the first, second, third, and fourth processing units 160, 162, 164, 166 in the embodiment of FIG. 3) may execute a relevant function or functions in software to perform an appropriate processing or a plurality of processes according to the modes. In other embodiments, an analog circuit and/or a digital circuit configured to execute the appropriate processing for the respective modes may be provided, and various data may be processed by an appropriate circuit(s) based on the setting of the setting unit 14.

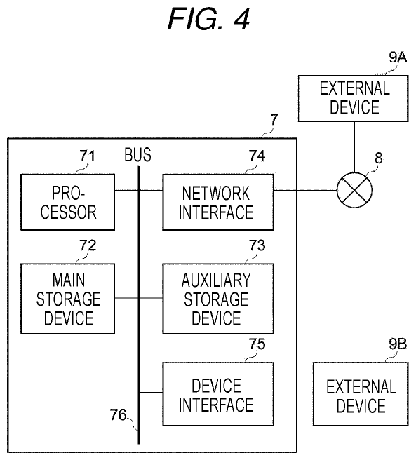

FIG. 4 is a block diagram illustrating an example of a hardware implementation of an information processing device 1. The information processing device 1 may be implemented as a device 7 which comprises a processor 71, a main storage device 72, an auxiliary storage device 73, a network interface 74, and a device interface 75. These components are connected to each other via a bus 76. The device 7 itself may be a computer device that can be independently powered on/off or may be an accelerator incorporated in, or connected to, a larger computer device that can be independently powered on/off.

The device 7 may comprise each depicted component in FIG. 4 or may comprise a plurality of these depicted components, such as two or more processors 71, connected to the bus 76. Further, although just one device 7 is illustrated in FIG. 4, appropriate software may be installed in a plurality of such computer devices so that each of the computer devices may execute processing according to software in a distributed manner.

In one embodiment, the processor 71 is an electronic circuit that operates as a processing circuit including a controller and an arithmetic unit. The processor 71 performs an arithmetic processing based on programs or data input from internal components of the device 7 and outputs an arithmetic result or a control signal to these components. More specifically, for example, the processor 71 controls each component of the device 7 by executing an operating system (OS) of the device 7, an application, or the like. The processor 71 is not limited to any specific configuration or function as long as the processor 71 can perform the processing according to the above-described embodiments. In general, the information processing device 1 or the device 7 and each component thereof may be implemented by the processor 71.

The main storage device 72 is a storage device that stores various instructions, programs, data, information and the like, which are directly read by the processor 71. The auxiliary storage device 73 is a storage device other than the main storage device 72. Such storage devices may comprise electronic components capable of storing electronic information and the like, and each may be a memory or a storage. The memory may include both or either of a volatile memory and a non-volatile memory. In another embodiment, a memory for storing various programs and data in the information processing device 1 may be implemented by the main storage device 72 or the auxiliary storage device 73. In still another embodiment, a storage unit may be implemented in the main storage device 72 or the auxiliary storage device 73. Ina further embodiment, if the device 7 further comprises an accelerator, the storage unit may be implemented in a memory of the accelerator.

The network interface 74 is an interface for connection to the communication network 8 in a wireless or wired manner. The network interface 74 may conform to existing communication standards. The network interface 74 may perform exchange of information with an external device 9A that is communicatively connected thereto via the communication network 8.

The external device 9A includes, for example, a stereo camera, a motion capture, an output destination device, an external sensor, or an input source device. The external device 9A may be a device capable of performing some functions of the components of the device 7 (or the information processing device 1). The device 7 (or the information processing device 1) may send and receive all or part of the results of the processing executed by the processor 71 via the communication network 8 in a similar manner to a cloud-based service.

The device interface 75 is an interface, such as a universal serial bus (USB), that is directly connected to an external device 9B. The external device 9B may be an external storage medium or a storage device. The storage unit may be implemented by the external device 9B.

The external device 9B may be an output device. The output device may be, for example, a display device for displaying an image or a device for outputting sound. Examples of the output device include, but are not limited to, a liquid crystal display (LCD), a cathode ray tube (CRT), a plasma display panel (PDP), and a speaker. The output device may be a component of an automobile that is controlled via a control area network (CAN).

The external device 9B may be an input device. The input device may comprise devices such as a keyboard, a mouse, and a touch panel and is configured to provide the device 7 with various information input from these devices. A signal or other information from the input device is received by the device interface 75 and fed to the processor 71 through the bus 76.

At least a part of the information processing device 1 may be implemented by hardware or may be implemented by software. In the latter case, for example, a CPU or a processor performs the information processing or programs of the software. Such programs may be stored in a storage medium and may be read out and executed by a computer. The storage medium may be a removable medium such as a magnetic disk or an optical disk including, but not limited to, a flexible disk, a CD-ROM, and the like. The storage medium may be a fixed storage medium such as a hard disk device or a memory. The information processing by software may be implemented using hardware resources. The information processing by software may be implemented by a circuit such as a field-programmable gate array (FPGA) and may be executed by hardware.

In one embodiment, a computer may constitute the information processing device 1 or the device 7 as the computer reads out the dedicated software or programs stored in a non-transitory computer-readable storage medium. The storage medium is not limited to any specific types so long as it stores the software or programs and other necessary data to be executed by the computer or its processor. In another embodiment, a computer may constitute the information processing device 1 or the device 7 as the dedicated software or programs are downloaded via a communication network and installed in the computer. In this way, the information processing by software is implemented using hardware resources.

While certain embodiments have been described, these embodiments have been presented by way of example only and are not intended to limit the scope of the inventions . Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a processor configured to:
receive input signals from a plurality of external devices;
receive a plurality of sensor signals from a plurality of sensors;
select a processing mode for each input signal from the plurality of external devices based at least in part on the plurality of sensor signals, the processing mode being selected from available processing modes including a normal mode and a low load mode with a lower processing load than the normal mode; and
process a first input signal of the input signals in the low load mode and a second input signal of the input signals in the normal mode.

2. The information processing device according to claim 1, wherein the processor is further configured to select the processing mode based on a previously processed input signal from one of the plurality of external devices.

3. The information processing device according to claim 2, wherein the external devices are cameras mounted on a vehicle, and the processing performed in each of the available processing modes comprises image analysis for vehicle obstacle avoidance.

4. The information processing device according to claim 1, wherein
the external devices are cameras mounted on a vehicle,
the plurality of sensors is mounted on the vehicle, and
the processing performed in each of the available processing modes comprises image analysis for vehicle obstacle avoidance.

5. The information processing device according to claim 4, wherein
the sensor signals from the plurality of sensors indicate a direction of travel for the vehicle,
the second input signal is from a camera positioned on the vehicle to capture an image corresponding to the direction of travel, and
the first input signal is from a camera positioned on the vehicle to capture an image not corresponding to the direction of travel.

6. The information processing device according to claim 1, wherein
the available processing modes further include a high load mode having a higher processing load than that of the normal mode, and
the processor is further configured to select the high load mode for at least one of the input signals.

7. The information processing device according to claim 1, wherein
the external devices are cameras and the input signals are video images, and
the low load mode includes processing the video images at a reduced frame rate as compared to the normal mode.

8. The information processing device according to claim 1, wherein
the external devices are cameras and the input signals are video images, and
the low load mode includes processing the video images at a reduced image resolution as compared to the normal mode.

9. The information processing device according to claim 1, wherein the processing mode for each input signal is selected according to which external device of the plurality of external device provides the input signal.

10. A vehicle-based image processing device, comprising:
a plurality of cameras providing image signals;
a plurality of sensors providing a plurality of sensor signals; and
a processor configured to:
receive the image signals from the plurality of cameras;
receive the plurality of sensor signals from the plurality of sensors;
select a processing mode for each image signal from the plurality of external devices based at least in part on the plurality of sensor signals, the processing mode being selected from available processing modes including a normal mode and a low load mode with a lower processing load than the normal mode; and
process a first image signal from a first camera in the plurality of cameras in the low load mode and a second image signal from a second camera in the plurality of cameras in the normal mode.

11. The vehicle-based image processing device according to claim 10, wherein the processor is further configured to select the processing mode based on a previously processed image signal from one of the plurality of cameras.

12. The vehicle-based image processing device according to claim 11, wherein the processing performed in each of the available processing modes comprises image analysis for vehicle obstacle avoidance.

13. The vehicle-based image processing device according to claim 10, wherein the processing performed in each of the available processing modes comprises image analysis for vehicle obstacle avoidance.

14. The vehicle-based image processing device according to claim 13, wherein
the sensor signals from the plurality of sensors indicate a direction of travel,
the second image signal is from a camera positioned to capture an image corresponding to the direction of travel, and
the first image signal is from a camera positioned on to capture an image not corresponding to the direction of travel.

15. The vehicle-based image processing device according to claim 10, wherein
the available processing modes further include a high load mode having a higher processing load than that of the normal mode, and
the processor is further configured to select the high load mode for at least one of the image signals

16. A non-transitory computer-readable medium storing a program therein, which when executed, causes a computer to perform
a process comprising:
receiving input signals from a plurality of external devices;
receiving a plurality of sensor signals from a plurality of sensors;
selecting a processing mode for each input signal from the plurality of external devices based at least in part on the plurality of sensor signals, the processing mode being selected from available processing modes including a normal mode and a low load mode with a lower processing load than the normal mode; and
processing a first input signal of the input signals in the low load mode and a second input signal of the input signals in the normal mode.

17. The non-transitory computer-readable medium according to claim 16, the process further comprising:
selecting the processing mode based on a previously processed input signal from one of the plurality of external devices.

18. The non-transitory computer-readable medium according to claim 16, wherein the processing performed in each of the available processing modes comprises image analysis for vehicle obstacle avoidance.

19. The non-transitory computer-readable medium according to claim 16, wherein the available processing modes further include a high load mode having a higher processing load than that of the normal mode.

20. The non-transitory computer-readable medium according to claim 16, wherein
the external devices are cameras and the input signals are video images, and
the low load mode includes processing the video images at a reduced frame rate as compared to the normal mode.
